(19) United States
(12) Patent Application Publication
(10) Pub. No.: US 2026/0081254 A1
(43) Pub. Date: Mar. 19, 2026

(54) FLUID-COOLED ELECTROCHEMICAL CELL CONFIGURATIONS AND RELATED ARTICLES, SYSTEMS, AND METHODS

(71) Applicant: Sion Power Corporation, Tucson, AZ (US)

(72) Inventors: Jared M. Jennings, Tucson, AZ (US); Bryce Yazzie, Marana, AZ (US); Mark Niedzwiecki, Tucson, AZ (US)

(73) Assignee: Sion Power Corporation, Tucson, AZ (US)

(21) Appl. No.: 18/885,306

(22) Filed: Sep. 13, 2024

(51) Int. Cl. H01M 10/6552; H01M 4/38; H01M 10/613; H01M 10/625; H01M 10/6567; H01M 50/249; H01M 50/502

(52) U.S. Cl. CPC H01M 10/6552; H01M 4/382; H01M 10/613; H01M 10/625; H01M 10/6567; H01M 50/249; H01M 50/502; H01M 2220/20

(57) ABSTRACT

Fluid-cooled electrochemical cell configurations and related articles, systems, and methods are generally described.

### TECHNICAL FIELD

Fluid-cooled electrochemical cell configurations and related articles, systems, and methods are generally described.

### SUMMARY

Fluid-cooled electrochemical cell configurations and related articles, systems, and methods are generally described. The subject matter of the present disclosure involves, in some cases, interrelated products, alternative solutions to a particular problem, and/or a plurality of different uses of one or more systems and/or articles.

Some aspects are related to battery modules.

In some embodiments, the battery module comprises a housing defining an interior volume; an electrochemical cell within the interior volume; and a heat sink within the interior volume, the heat sink comprising a conduit extending from the interior volume of the housing to an exterior of the housing through an opening in the housing, wherein the opening in the housing is sized to permit movement of the conduit in a first direction that is substantially perpendicular to a second direction in which fluid is configured to flow through the conduit.

In some embodiments, the battery module comprises a housing defining an interior volume and comprising an interface; a plurality of electrochemical cells within the interior volume, each electrochemical cell having a first terminal of a first polarity and a second terminal having a second polarity opposite the first polarity; a heat sink within the interior volume; an electrical connection spanning the interface and establishing electrical communication between at least one terminal of the plurality of electrochemical cells and a terminal outside the housing; and a conduit extending from the interior volume of the housing to an exterior of the housing through the interface.

In some embodiments, the battery module comprises a housing defining an interior volume; an electrochemical cell within the interior volume; a heat sink within the interior volume comprising a fluid flow pathway within the heat sink, a fluid manifold; and a flexible conduit fluidically connecting the fluid manifold and the fluid flow pathway.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIGS. 1A-1C show various views of a battery module, according to some embodiments;

FIG. 2 shows an electrochemical cell, according to some embodiments;

FIGS. 3A-3C show various views of a heat sink, according to some embodiments;

FIGS. 4A-4C show a portion of the housing of the battery module including a fluid manifold and plurality of openings, according to some embodiments;

FIG. 5 shows a cross-sectional view of a battery module, according to some embodiments;

FIGS. 6A and 6B show a battery module before and after applying an anisotropic force, respectively, according to some embodiments;

FIG. 7 is a cross-sectional view schematic illustration showing an electrochemical cell, according to some embodiments; and

FIG. 8 is a cross-sectional view schematic illustration showing an electric vehicle comprising a battery module, according to some embodiments.

### DETAILED DESCRIPTION

Fluid-cooled electrochemical cell configurations and related articles, systems, and methods are generally described. In certain embodiments, the electrochemical cell can be within a battery module. In certain cases, the battery module includes a housing that is configured to permit lateral movement of a conduit that runs through an opening of the housing to an electrochemical cell therein, for example, by sizing the opening in the housing such that the conduit that passes through it can move laterally. Configuring the battery module in this way can allow for some amount of tolerance in the lateral movement of the conduit, which can thus accommodate expansion and shrinkage of electrochemical cells within the battery module without rupturing the conduit.

In some embodiments, the battery module can be configured such that both an electrical connection to the electrochemical cell(s) within the battery module (e.g., for charging the electrochemical cell(s) and/or discharging the electrochemical cell(s) through a load) and a conduit (e.g., for transporting a fluid, such as a cooling fluid into and/or out of the interior of the battery module) can extend through a common interface of the battery module housing (e.g., through a single surface of the module housing when it is in the shape of a rectangular prism). Organizing the electrical and fluidic connections in this way can, in some cases, make it easier to manage the electrical and fluidic connections to the battery module.

In still further aspects, certain embodiments involve the use of flexible conduits for fluidically connecting a source of fluid to the interior of a battery module. Using flexible conduits can allow for lateral movement of the fluid conduits without rupturing them, allowing for relatively easy cooling of the interior of a battery module without leakage.

The heat sinks described herein are, in accordance with certain embodiments, active heat sinks. That is to say, in accordance with some embodiments described herein, the heat sinks can be configured such that a fluid (e.g., a liquid, such as a liquid coolant) can be transported over or through a solid component of the heat sink such that heat is transferred from the solid component to the fluid. As one example, in some embodiments, the heat sink can include a solid plate within which a channel (e.g., an open channel or a closed channel) has been formed, and the channel can be configured to allow the transport of a fluid (e.g., a liquid) through it to dissipate heat from the solid plate.

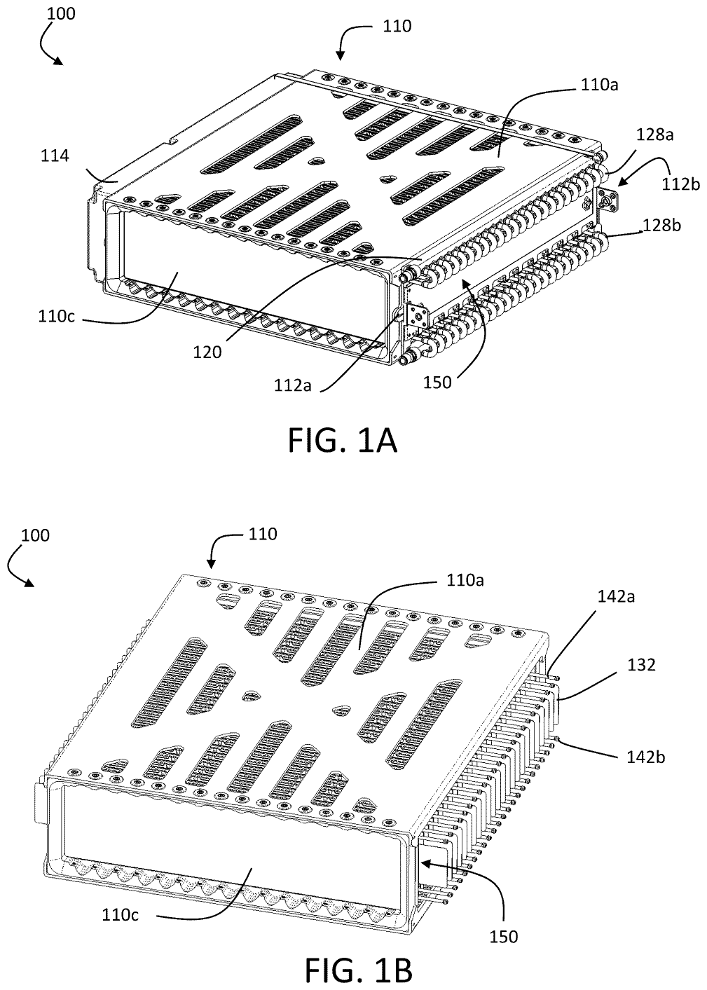

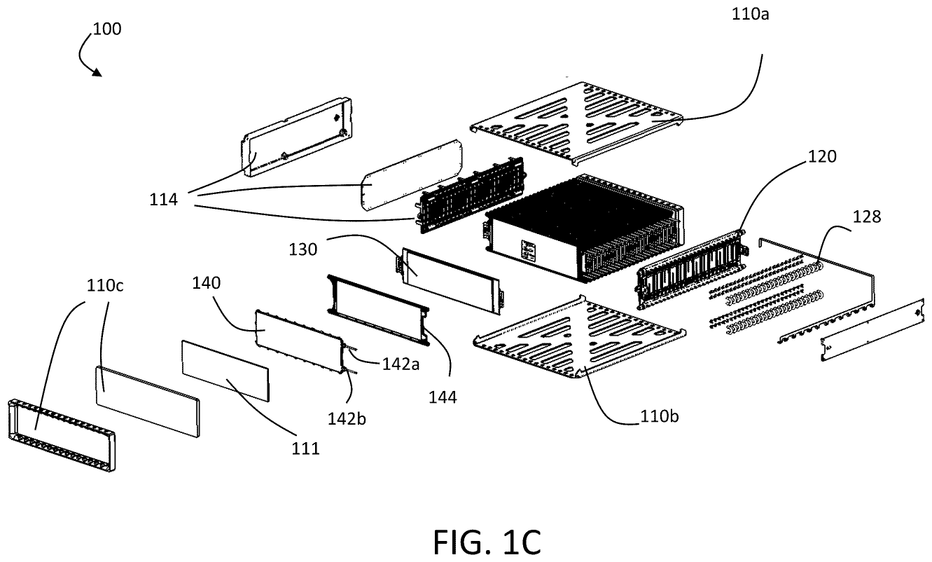

As noted above, certain aspects of the present disclosure are related to battery modules. In some embodiments, the battery modules may comprise a housing defining an interior volume containing an electrochemical cell and/or a heat sink. An example battery module is depicted in FIG. 1A, which is described in more detail elsewhere herein. In some embodiments, the housing includes an opening sized to permit movement of conduits within which heat sink fluid travels from an interior of the housing to an exterior of the housing. In accordance with some embodiments, the housing includes an interface through which a conduit may extend from the interior of the housing and/or an electrical connection that may establish electrical communication to the electrochemical cell contained within the housing. In certain embodiments, the battery module may include a fluid manifold and a flexible conduit fluidically connecting the fluid manifold to a fluid flow pathway of the heat sink within the housing of the battery module. Still other aspects are related to methods, articles including the battery modules, systems including the battery modules, or the like.

Batteries are generally operated by cycling the electrochemical cells of the battery between various states of charge and discharge. When certain battery chemistries are used, such as lithium-metal battery chemistry and certain lithium-ion battery chemistries, the electrochemical cells of the battery modules may “breathe,” meaning the volume of the electrochemical cells may expand and/or contract as materials within the electrochemical cells are deposited and/or removed from the electrodes during cycling. In some embodiments, the electrochemical cells may age when cycled (e.g., greater than or equal to 10 cycles, greater than or equal to 20 cycles, greater than or equal to 50 cycles, greater than or equal to 100 cycles, greater than or equal to 500 cycles and/or less than or equal to 8,000 cycles, less than or equal to 5,000 cycles, less than or equal to 3,000 cycles, less than or equal to 2,000 cycles, less than or equal to 1,000 cycles, and/or than or equal to 800 cycles). Aging of the electrochemical cells may result in irreversible chemical reactions (e.g., forming electrically isolated lithium, forming precipitates, etc.), which may also result in the expansion or contraction of the electrochemical cells. The expansion and contraction of such batteries may be deleterious to the operation of battery modules containing such electrochemical cells, as a housing of the battery module, electrical connections thereto, and/or fluidic connections thereto may not be designed to accommodate such movement.

Accordingly, some aspects are generally related to battery modules having a housing containing one or more heat sinks, where the housing includes holes through which a conduit that is part of and/or that is fluidically connected to the heat sink contained may extend. In some embodiments, the holes of the housing are sized to permit movement of the conduit in at least a first direction that is substantially perpendicular to a second direction in which fluid is configured to flow through the conduit. In such a manner, in some embodiments, the openings may allow the conduit to move when the electrochemical cell expands and/or contracts (e.g., during breathing of the electrochemical cell(s)). This movement may be accommodated without damaging the conduit and/or leaking fluid from the conduit.

Additionally, in certain cases, the battery modules described herein may further include a fluid manifold configured to flow fluid from an exterior of the housing of the battery module to the heat sinks contained within the housing. As noted above, certain electrochemical cells may expand and contract, which may complicate providing fluidic connections to heat sinks contained within the housing. Thus, in some embodiments, the battery modules may further include a flexible conduit extending from the fluid manifold to a fluid flow pathway of the heat sink. Such a flexible conduit, in some embodiments, may facilitate and maintain fluidic connection between the heat sink and the fluid manifold while accommodating for movement of the heat sink when the electrochemical cell(s) of the battery module expands and/or contracts during cycling. Such movement can be accommodated, in accordance with certain embodiments, without leakage of the fluid from the fluid flow pathway.

In accordance with certain embodiments, it may be desirable to establish electrical connections and fluid connections to the battery module (e.g., for powering a load external to the battery module during discharging, for charging the electrochemical cells in the battery module during charging, and/or for transporting cooling fluid to and/or from the battery module). Having such connections on multiple interfaces may necessitate components exterior of the housing (e.g., electrical connections, fluidic connections) from various directions relative to the battery module, which may be undesirable in applications where decreasing the volume of the battery module and associated components is desired. Moreover, various connections of multiple interfaces may require a more accessible battery module, e.g., for connections thereto.

Accordingly, certain aspects are generally directed to battery modules including an interface, where an electrical connection spanning the interface establishes electrical communication between at least one terminal of the plurality of electrochemical cells and a terminal outside the housing, and where a conduit extends from the interior of the battery module housing volume through the interface to the exterior of the battery module housing. In certain embodiments, having electrical connections and fluidic connections through a single interface of the battery module may advantageously allow the battery module to be positioned in a smaller volume accessible from substantially a single direction (e.g., via the interface) when compared to battery modules having electrical connections and fluidic connections on multiple interfaces. Moreover, in certain embodiments, by having the electrical connections and fluidic connections made through a single interface, the battery module may be configured to be stackable with other battery modules, e.g., due to interfaces of the battery modules being substantially planar due to the absence of electrical and/or fluidic connections therethrough.

FIGS. 1A-1C show various views of an example of a battery module 100, according to some embodiments. FIG. 1A shows a perspective view of a battery module 100, which includes a housing 110 comprising top portion 110a and side portion 110c comprising a fluid manifold 120. The battery module contains a plurality of electrochemical cells and a plurality of heat sinks. The fluid manifold 120 is connected to a plurality of flexible conduits 128a and 128b fluidically connecting the fluid manifold 120 to fluid flow pathways of the heat sinks contained within the battery module. The battery module 100 further includes an electrical connection 112a configured to establish electrical communication between at least one terminal of the electrochemical cells contained in the battery module 100 and a terminal outside the housing 110. A back carrier assembly 114 of the battery module 100 is also depicted. The back carrier assembly may contain additional electrical components, e.g., a battery management system (BMS) circuit board.

FIG. 1B shows a partial cutaway view of FIG. 1A where the fluid manifold 120, flexible conduits 128, electrical connection 112a, and back carrier assembly 114 are not shown. Accordingly, FIG. 1B depicts tabs 132 of a plurality of electrochemical cells 130 and conduits 142a and 142b extending from a plurality of heat sinks 140 extending from an interior to an exterior of the housing 110. FIG. 1C shows a partial exploded view of the battery module 100. FIG. 1C illustrates that the housing 110 includes a top portion 110a, a bottom portion 110b, and side portions 110c. FIG. 1C depicts that the interior volume of the housing of the battery module 100 contains foam layer 111, electrochemical cells 130, and heat sinks 140. FIG. 1C further shows bracket 144 configured to receive heat sinks 140 to maintain an orientation of the heat sink 140 within the housing 110 of the battery module 100.

In accordance with some embodiments, the housing of the battery module at least partially defines an interior volume. In some embodiments, the interior volume is sized and shaped to hold one or more electrochemical cells and/or heat sinks. In some embodiments, the interior volume contains one or more electrochemical cells and/or heat sinks. In some embodiments, the interior volume contains a plurality of electrochemical cells and/or a plurality of heat sinks. For instance, referring again to FIG. 1C, the housing 110 of the battery module 100 comprises top portion 110a, bottom portion 110b, and side portions 110c, together at least partially defining an interior volume of the battery module 100 configured to receive one or more electrochemical cells 130 and/or one or more heat sinks 140. In FIGS. 1A-1C, the housing 110 contains at least one foam layer, a plurality of electrochemical cells 130, and a plurality of heat sinks 140.

In some embodiments, at least one foam layer may be included within the battery module. In some instances, the at least one foam layer may be configured to be reversibly compressible. For instance, as described in more detail elsewhere herein, the electrochemical cells may expand and/or contract upon cycling. In some such embodiments, the at least one foam layer may at least partially accommodate for the expansion and/or contraction of the electrochemical cells. An example of a foam layer 111 is illustrated in FIG. 1C.

The electrochemical cells described herein, in accordance with some embodiments, may use any of a variety of cell chemistries. In some embodiments, the electrochemical cells are lithium ion containing electrochemical cells (e.g., in the case where a lithium-ion battery is used). In some embodiments, the electrochemical cells may be lithium metal electrochemical cells (e.g., when a lithium metal battery is being used). Examples of various cell chemistries are provided in more detail below.

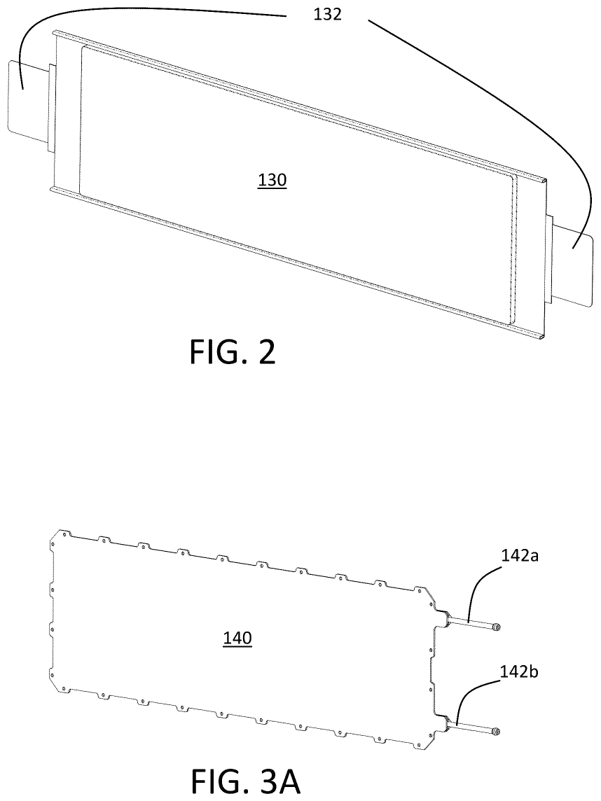

In certain embodiments, the electrochemical cells comprise terminals (e.g., tabs). For example, FIG. 2 depicts a schematic diagram of an electrochemical cell 130 that include tabs 132. The tabs may serve, for example, as terminals for electrical communication to the electrochemical cell. The tabs of the electrochemical cell may extend outside of the housing containing the electrochemical cell, e.g., to facilitate electrical connection thereto, as shown in FIG. 1B.

In some embodiments, cycling of the electrochemical cell(s) (e.g., sequentially charging and discharging the cell) may result in the electrochemical cells generating heat. Accordingly, in some embodiments, one or more heat sinks may be included in the battery module and may be arranged and configured to transfer heat away from the electrochemical cells. According to some embodiments, the battery module includes a plurality of heat sinks. In some embodiments, when the battery module comprises a plurality of heat sinks and a plurality of electrochemical cells, the heat sinks and electrochemical cells may be contained within an interior volume of the housing of the battery module. In some embodiments, at least one heat sink is positioned between two electrochemical cells. In certain embodiments, for at least two, at least three, at least five, or at least ten heat sinks within the battery module, that heat sink has an electrochemical cell positioned on one side of it and another electrochemical cell positioned on another side of it. In certain embodiments, at least one electrochemical cell is positioned between two heat sinks. In certain embodiments, for at least two, at least three, at least five, or at least ten electrochemical cells within the battery module, that electrochemical cell has a heat sink positioned on one side of it and another heat sink positioned on another side of it. In some such embodiments, the heat sinks and electrochemical cells may be arranged to alternate, for example, to better facilitate heat transfer from the electrochemical cells to the heat sinks. For example, in some embodiments, the battery module comprises at least the following components arranged in the order listed: a first electrochemical cell, a first heat sink, a second electrochemical cell, and a second heat sink. In certain embodiments, the battery module comprises at least the following components arranged in the order listed: a first electrochemical cell, a first heat sink, a second electrochemical cell, a second heat sink, a third electrochemical cell, a third heat sink, a fourth electrochemical cell, and a fourth heat sink. In certain embodiments, the battery module comprises at least 2 (or at least 5, at least 10, at least 15, at least 20, at least 25, or more) electrochemical cells and at least 2 (or at least 5, at least 10, at least 15, at least 20, at least 25, or more) heat sinks positioned in an alternating fashion. In some embodiments, at least one foam layer may additionally be positioned between two electrochemical cells. For instance, in some embodiments, the battery module comprises at least the following components arranged in the order listed: a first foam layer, a first heat sink, a first electrochemical cell, a second foam layer, a second heat sink, and second electrochemical cell.

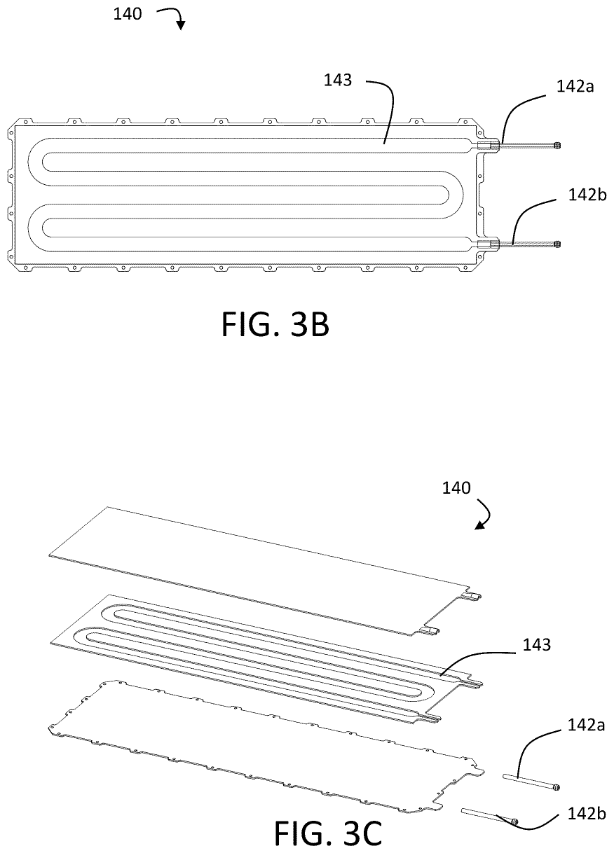

FIGS. 3A-3C show an example embodiment of a heat sink 140. FIG. 3A shows a perspective view of the heat sink 140 including two conduits 142a and 142b. The cross-sectional view and exploded view of the heat sink shown in FIGS. 3B and 3C, respectively, show the heat sink 140 includes a fluid flow pathway 143 defined within the interior of the heat sink 140. The two conduits 142a and 142b of the heat sink are fluidically connected to the fluid flow path 143 and may serve as an inlet and outlet to the fluid flow pathway 143. According to some embodiments, the conduits (e.g., the inlet and/or outlet), as shown as 142a and 142b in the example embodiment of FIG. 1B, may extend from an interior of the housing of the battery module to an exterior of the battery module through respective openings.

While the heat sinks described above are depicted with two conduits and a single fluid flow pathway, other arrangements are also possible, in accordance with some embodiments. The heat sink may be configured to flow a fluid through the fluid flow pathway. For instance, in some embodiments, the heat sink comprises or is a cooling plate. In doing so, the fluid may receive heat from an electrochemical cell positioned adjacent to the heat sink. Any of a variety of suitable fluids may be selected to flow through the fluid flow pathway of the heat sink, in some embodiments, including oxygen, nitrogen, air (e.g., atmospheric gas), water, ethylene glycol, coolants, and/or combinations thereof. Other fluids are also possible. In certain embodiments, it can be advantageous to use a liquid as the fluid flowed through the heat sink. Liquid can be used alone (using one or more liquid components), or it can be used in combination with one or more gases. In some embodiments, at least 75 vol %, at least 90 vol %, at least 95 vol %, at least 99 vol %, or more (e.g., all) of the fluid is in a liquid state.

In some embodiments, heat sinks include a fluid flow path through which the fluid may flow, where the fluid may be configured to receive heat from the electrochemical cells and then flow out of the heat sink. In some embodiments, to further facilitate heat transfer, the heat sink may comprise a material that is thermally conductive. For example, in some embodiments, the solid material from which the heat sink is made may have a thermal conductivity of at least 10 W/m-K, at least 50 W/m-K, at least 100 W/m-K, at least 250 W/m-K, at least 500 W/m-K, at least 1000 W/m-K, or more (e.g., up to 2000 W/m-K, up to 3000 W/m-K, or more). In some embodiments, the heat sink may comprise a metallic material, such as copper, aluminum, stainless steel, other metals, and/or combinations of these. In some embodiments, the heat sink may comprise an aluminum alloy.

As noted above, in some embodiments, certain chemistries of the electrochemical cell may result in expansion and/or contraction (e.g., breathing, aging) of the electrochemical cell during cycling.

In some embodiments, expansion and/or contraction of an electrochemical cell during cycling may undesirably complicate connections between external components of the battery module and interior components of the battery module due to the movement of interior components during electrochemical cycling. For instance, fluidic connections to heat sinks that are alternately arranged with electrochemical cells may not be compatible with electrochemical cells that expand and/or contract during cycling, in some embodiments. For example, in typical battery modules, heat sinks may not be configured to move during cycling of electrochemical cells, which may not be compatible with certain chemistries that may expand and/or contract during cycling and accordingly move the heat sinks. In some embodiments, fluidic connections to heat sinks may be susceptible to wear during electrochemical cycling due to continuous movement, e.g., between charged and discharged states of electrochemical cells of the battery module moving the fluidic pathway.

Accordingly, in some embodiments, the battery module includes a housing having an opening through which a conduit of a heat sink contained within the housing extends to facilitate flow of a fluid from a location external to the housing to a fluid flow path of the heat sink contained within the housing. Advantageously, in some embodiments, the opening in the housing is sized to permit movement of the conduit in a first direction that is substantially perpendicular to a second direction in which fluid is configured to flow through the conduit. In some embodiments, the first direction corresponds to a direction of expansion and/or contraction of electrochemical cells contained within the battery module so that movement of the conduits of heat sinks that arises due to the expansion and/or contraction of the electrochemical cells may be accommodated. In some embodiments, the size of the openings may include sufficient tolerance to facilitate movement of the conduits of the heat sinks during expansion and/or contraction of the electrochemical cells without the conduits colliding with other portions of the housing (e.g., a side of the opening).

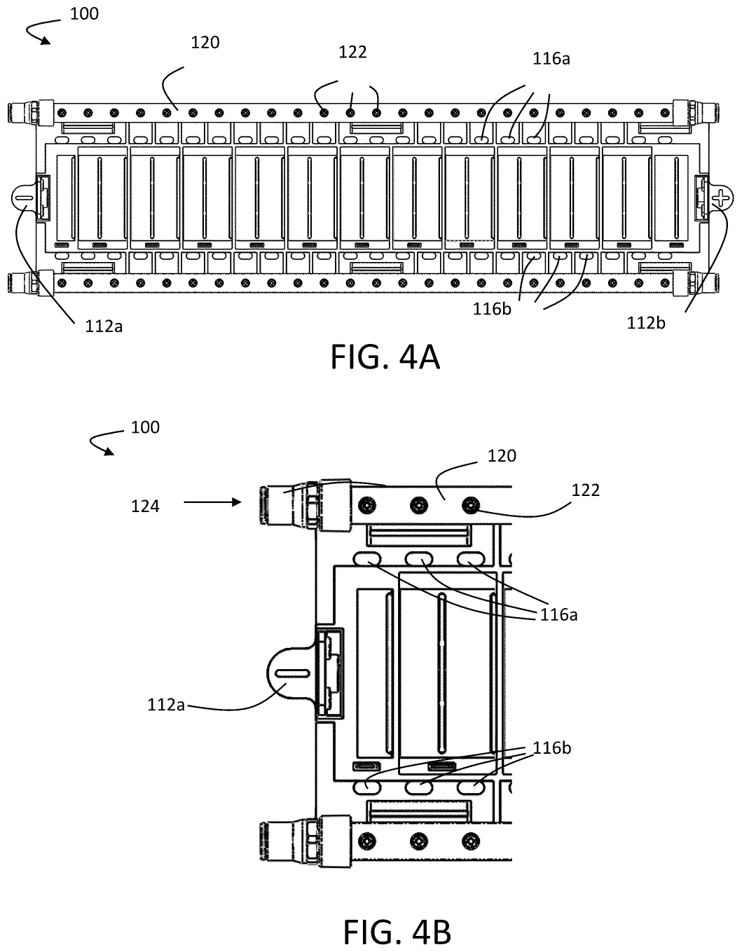

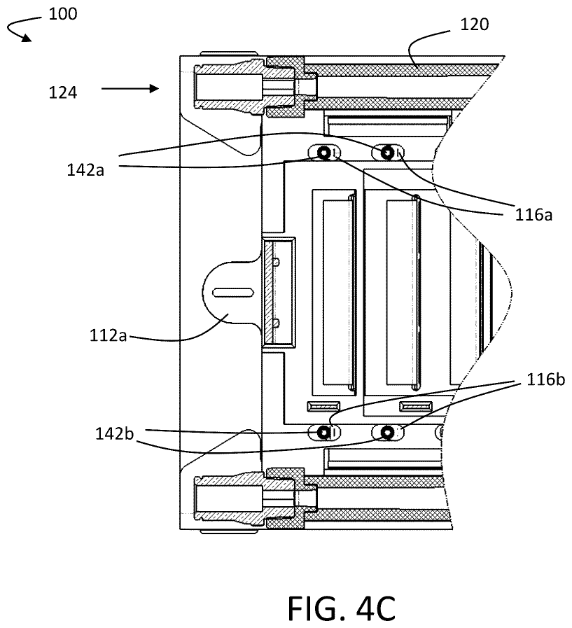

FIGS. 4A-4C show an end-on view of an example embodiment of a battery module 100 where the housing of the battery module 100 includes a fluid manifold 120 having fluidic connections 122 configured to be fluidically connected to conduits of heat sinks (e.g., conduits 142a and 142b in FIGS. 1B and 3A-3C) and fluidic inlets 124 configured to be fluidically connected to a source of fluid, e.g., that may be external of the battery module. The housing of the battery module 100 further includes openings 116a and 116b configured for conduits fluidically connected to channels of the heat sinks to extend therethrough. For instance, FIG. 4C shows the housing 110 including openings 116a and 116b with conduits 142a and 142b extending therethrough (e.g., out of the page). Openings 116a and 116b (and other openings) are sized and shaped such that, when conduits pass through them, the conduits may move in a side-to-side direction, which is substantially perpendicular to the direction in which fluid flows through the conduits (which would be into and out of the page in FIGS. 4A-4B). Accordingly, the openings 116a and 116b are sized to permit movement of respective conduits extending therethrough from the interior volume of the housing 110 to the exterior of the housing. In some embodiments, as depicted in FIGS. 4A and 4B, the housing of the battery module may include a plurality of openings through which corresponding conduits from a plurality of heat sinks may extend. In some embodiments, a first opening may correspond to a conduit from a first heat sink, a second opening may correspond to a conduit from a second heat sink, and so forth, for the plurality of the openings and conduits. In some embodiments, certain openings may be sized to accommodate more than one conduit therethrough and associated movement thereof. For instance, in some embodiments, two conduits from two separate heat sinks may extend through a single opening in the housing. In some embodiments, three conduits from three separate heat sinks may extend through a single opening in the housing. In some embodiments, a single conduit from each heat sink may collectively pass through a single opening.

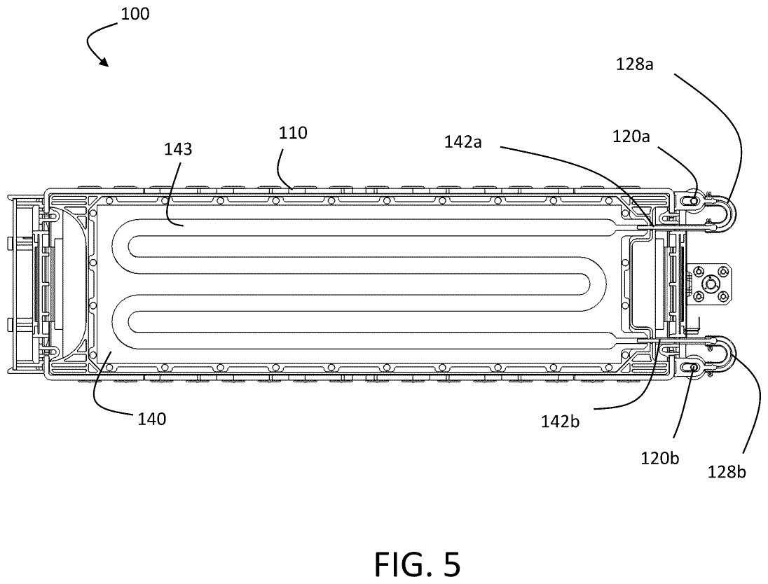

In some embodiments, there may be sufficient openings arranged to accommodate multiple conduits (e.g., at least 2, at least 4, at least 6, at least 8, and/or up to 10, up to 12, up to 14, up to 16, up to 18, and/or up to 20) from each heat sink extending from the interior volume of the housing to external of the housing. In some embodiments, there may be sufficient openings arranged to accommodate two conduits from each heat sink extending from the interior volume of the housing to external of the housing. For instance, as shown in FIG. 4B, a first set of openings 116a may be arranged for a corresponding first conduit from a plurality of heat sinks to pass therethrough while a second set of openings 116b may be arranged for a corresponding second conduit from a plurality of heat sinks to pass therethrough. In some such embodiments, the first set of conduits may serve as inlets for fluid flow into the fluid flow pathways of the heat sinks and the second set of conduits may serve as outlets for fluid flow out of the fluid flow pathways of the heat sinks. This can be better seen in the cross-sectional view of FIG. 5 of battery module 100, showing a heat sink 140 contained within the housing 110, with a first and second conduit 142a and 142b extending from the fluid flow pathway 143 of the heat sink 140 through openings in the housing 110 to an exterior of the housing. The first conduit 142a is fluidically connected to a first flexible conduit 128a that is fluidically connected to a first fluid manifold 120a, while the second conduit 142b is fluidically connected to a second flexible conduit 128b that is fluidically connected to a second fluid manifold 120b. In the example embodiment shown in FIG. 5, the first conduit 142a serves as an inlet for fluid flow into the fluid flow pathway 143 and the second conduit 142b serves as an outlet for fluid flow out of the fluid flow pathway 143.

In certain embodiments, the opening(s) in the housing sized to permit movement of the conduit can be relatively large, for example, so as to accommodate a relatively large degree of movement of the conduit, e.g., upon expansion and/or contraction of electrochemical cells contained with the housing. In some embodiments, the cross-sectional area of the opening is at least 1.5 times, at least 2 times, at least 2.5 times, at least 3 times, at least 5 times, or at least 10 times (and/or up to 10 times, or up to 20 times, or more) larger than the cross-sectional area of the portion of the conduit passing through the opening. In some embodiments, the cross-sectional area of the opening is less than or equal to 20 times, less than or equal to 10 times, less than or equal to 5 times, less than or equal to 3 times, less than or equal to 2.5 times, or less than or equal to 2 times the cross-sectional area of the portion of the conduit passing through the opening. In some embodiments, the opening in the housing is sized to permit movement of the conduit a distance along the first direction that is at least 0.5 times, at least 1 time, at least 1.5 times, at least 2 times, at least 2.5 times, at least 3 times, at least 5 times, or at least 10 times (and/or up to 10 times, or up to 20 times, or more) the smallest outer cross-sectional dimension of the conduit passing through the opening. In some embodiments, the opening in the housing is sized to permit movement of the conduit a distance along the first direction that is less than or equal to 20 times, less than or equal to 10 times, less than or equal to 5 times, less than or equal to 3 times, less than or equal to 2.5 times, or less than or equal to 2 times the smallest outer cross-sectional dimension of the conduit passing through the opening.

In accordance with some embodiments, a maximum cross-sectional dimension of the opening is at least 1.5 times, at least 2 times, at least 2.5 times, at least 3 times, at least 5 times, or at least 10 times (and/or up to 15 times, or up to 20 times, or more) larger than the corresponding cross-sectional dimension of the portion of the conduit passing through the opening, to permit movement in the direction of the maximum cross-sectional dimension of the opening. In some embodiments, the maximum cross-sectional dimension of the opening is less than or equal to 20 times, less than or equal to 10 times, less than or equal to 5 times, less than or equal to 3 times, less than or equal to 2.5 times, or less than or equal to 2 times the corresponding cross-sectional dimension of the portion of the conduit passing through the opening.

In some embodiments, a minimum cross-sectional dimension of the opening is at least 1.5 times, at least 2 times, at least 2.5 times, at least 3 times, at least 5 times, or at least 10 times (and/or up to 15 times, or up to 20 times, or more) larger than the corresponding cross-sectional dimension of the portion of the conduit passing through the opening, which can permit movement in the direction of the minimum cross-sectional dimension of the opening. In some embodiments, the minimum cross-sectional dimension of the opening is less than or equal to 20 times, less than or equal to 10 times, less than or equal to 5 times, less than or equal to 3 times, less than or equal to 2.5 times, or less than or equal to 2 times the corresponding cross-sectional dimension of the portion of the conduit passing through the opening.

In some embodiments, where the portion of the conduit passing through the opening comprises a circular cross-section, then a maximum cross-sectional dimension of the opening is at least 1.5 times, at least 2 times, at least 2.5 times, at least 3 times, at least 5 times, or at least 10 times (and/or up to 15 times, or up to 20 times, or more) larger than the diameter of the conduit. In some embodiments, where the portion of the conduit passing through the opening comprises a circular cross-section, then a maximum cross-sectional dimension of the opening is less than or equal to 20 times, less than or equal to 10 times, less than or equal to 5 times, less than or equal to 3 times, less than or equal to 2.5 times, or less than or equal to 2 times the diameter of the conduit.

The battery module, in some embodiments, may include a fluid manifold. The fluid manifold may facilitate fluid flow from a source of fluid external of the battery module to the interior volume of the housing, e.g., through the fluid manifold, according to some embodiments. As opposed to typical battery modules including multiple connections from a fluid source to a battery module (e.g., to each heat sink therein), a single connection from the source of fluid to the battery module may be advantageous, in some embodiments, because it reduces the number of connections required between the battery module and components external to the battery module. In some embodiments, the fluid manifold may be an integral portion of the housing of the battery module. Accordingly, in some embodiments, the fluid manifold may not be removably detached from the housing without irreversibly changing (e.g., breaking) the housing. Such an integral fluid manifold, in some embodiments, may advantageously reduce the tubing length used between the fluid manifold and any heat sinks to which the fluid manifold is fluidically connected. In some embodiments, the fluid manifold may be separate from the housing, and may be configured to be reversibly coupled to the housing. In certain embodiments, reversibly coupling the fluid manifold to the housing may comprise reversibly attaching the fluid manifold to the housing, e.g., through one or more detents, screws, interlocking mechanical features, or the like.

In some embodiments, the fluid manifold is configured to be fluidically connectable to a fluid flow pathway of a heat sink contained within the housing of the battery module. For example, referring again for FIG. 5, fluid manifolds 120a and 120b are fluidically connected to the fluid flow pathway 143 of the heat sink 140 via flexible conduits 128a and 128b and conduits 142a and 142b, respectively. In some embodiments, the fluid manifold is configured to be fluidically connectable to each heat sink contained within the housing of the battery module. In some embodiments, the fluid manifold is configured to be directly and fluidically connected to each heat sink contained within the housing of the battery module. In certain embodiments, the fluid manifold is fluidically connected to each heat sink. In certain embodiments, the fluid manifold is directly fluidically connected to each heat sink, e.g., meaning fluid may flow directly from the fluid manifold to a first heat sink without passing through a second separate heat sink before the first. That is, in some embodiments, parallel fluid connections may be made from the fluid manifold to each of the one or more heat sinks contained within the battery module. For instance, again referring to FIGS. 4A and 4B, the fluid manifold 120 may include a plurality of fluidic connections 122, each of which may be directly connected to a conduit from a respective heat sink, the conduit extending through respective openings 116a of the battery module housing. Thus, fluid may flow directly from the fluid manifold via the openings 116 into each heat sink of the battery module. FIG. 5 depicts an example fluid path from a fluid manifold 120 to a fluid flow pathway 143 of a heat sink 140. The fluid manifold may include any of a number of suitable openings through which fluid may flow therethrough, e.g., from the fluid manifold to a heat sink, in some embodiments. In accordance with certain embodiments, the fluid manifold may include a corresponding number of openings through which fluid may flow as to the number of heat sinks contained within the housing of the battery module. The fluid manifold may further include an inlet and/or an outlet for fluidic connections to a fluid source and/or a fluid sink external to the battery module, in some embodiments.

In some embodiments, as described in more detail elsewhere herein, the heat sinks (and thus the corresponding conduits) contained within the housing of the battery module may move during cycling of the electrochemical cells. Advantageously, to accommodate for such movement, in some embodiments, a flexible conduit may be used to fluidically connect the fluid manifold to a conduit of a heat sink. In some embodiments, a plurality of flexible conduits may be used provide fluidic connection between the fluid manifold and a plurality of heat sinks (e.g., a first flexible conduit to a first heat sink, a second flexible conduit to a second heat sink, etc.). For instance, again referring to FIG. 5, flexible conduits 128a and 128b are fluidically connected to fluid manifolds 120a and 120b of battery module 100 and fluid flow pathway 143 of heat sink 140 contained within housing 110 of battery module 100. Additionally note that while in FIG. 5 the flexible conduit connects to a conduit of the heat sink at a position that is external to the housing of the battery module, it is also possible for the flexible conduit to extend into the interior volume of the housing of the battery module to fluidically connect to the fluid flow path of the heat sink contained therein, in some embodiments. In some embodiments, the flexible conduit may extend from the fluid flow path of the heat sink in the interior volume of the battery module to an exterior of the battery module, e.g., and connect to a fluid manifold.

In some embodiments, the flexible conduits may comprise any of a variety of suitable materials. In some embodiments, the flexible conduit comprises polyvinyl chloride (PVC), silicones, polyurethane, and/or thermoplastic elastomers. In some embodiments, it is desirable for the flexible conduit to be sufficiently flexible to provide movement in response to any expansion and/or contraction of electrochemical cells, while being sufficiently robust to avoid significant swelling, ballooning, and/or bursting during operation.

In certain embodiments, the flexibility of the flexible conduit may be determined by a Young's modulus of the flexible conduit, determined using an ASTM E111-17 (2017) standard test. In some embodiments, the Young's modulus of the flexible conduit is greater than or equal to 1 kPa, greater than or equal to 10 kPa, greater than or equal to 100 kPa, greater than or equal to 1 kPa, greater than or equal to 1 MPa, greater than or equal to 10 MPa, greater than or equal to 100 MPa, greater than or equal to 1 GPa, or more. In some embodiments, the Young's modulus of the flexible conduit is less than or equal to 100 GPa, less than or equal to 50 GPa, less than or equal to 10 GPa, less than or equal to 1 GPa, less than or equal to 100 MPa, less than or equal to 10 MPa, less than or equal to 1 MPa, less than or equal to 100 kPa, less than or equal to 10 kPa, or less. Combinations of the foregoing ranges are possible (e.g., greater than or equal to 1 kPa and less than or equal to 1 GPa). Other ranges are also possible.

In certain embodiments, the flexible conduit has a tensile strength in at least one dimension of at least 1 MPa, at least 5 MPa, at least 10 MPa, at least 20 MPa, at least 50 MPa, at least 100 MPa, at least 200 MPa, at least 500 MPa, at least 1 GPa, at least 2 GPa, at least 5 GPa, at least 10 GPa, or more. In some embodiments, the flexible conduit has a tensile strength in at least one dimension of less than or equal to 100 GPa, less than or equal to 10 GPa, less than or equal to 1 GPa, less than or equal to 100 MPa, less than or equal to 10 MPa, less than or equal to 1 MPa, or less. Combinations of the foreground ranges are also possible. Other ranges are also possible.

In certain embodiments, the flexible conduit has an elongation at break of at least 5%, at least 10%, at least 25%, at least 50%, at least 75%, at least 100%, at least 200%, at least 500%, at least 1000%, or more. In certain embodiments, the flexible conduit has an elongation at break of less than or equal to 10,000%; less than or equal to 5000%; less than or equal to 1000%; less than or equal to 500%; less than or equal to 250%; less than or equal to 100%; less than or equal to 50%; or less. Combinations of the foreground ranges are also possible. Other ranges are also possible.

In some embodiments, the flexible conduit is sufficiently flexible that it can be folded back on itself such that a first portion of the flexible conduit contacts a second portion of the flexible conduit without plastically deforming, fracturing, and/or cracking the flexible conduit. In some embodiments, the flexible conduit is sufficiently flexible that it can be folded back on itself such that a first portion of the flexible conduit can contact a second portion of the flexible conduit without fracturing and/or cracking the flexible conduit. In some embodiments, the flexible conduit can be flexed such that its long axis has a radius of curvature of less than or equal to 1 meter (or less than or equal to 50 cm, less than or equal to 25 cm, less than or equal to 10 cm, less than or equal to 5 cm, less than or equal to 1 cm, or less such as little as 0.5 cm, as little as 0.2 cm, as little as 0.1 cm, or less) without plastically deforming, fracturing, and/or cracking the flexible conduit. In some embodiments, the flexible conduit can be flexed such that its long axis has a radius of curvature of less than or equal to 1 meter (or less than or equal to 50 cm, less than or equal to 25 cm, less than or equal to 10 cm, less than or equal to 5 cm, less than or equal to 1 cm, or less such as little as 0.5 cm, as little as 0.2 cm, as little as 0.1 cm, or less) without fracturing and/or cracking the flexible conduit.

In certain embodiments, a relatively large degree of swelling of the electrochemical cells is observed, but the pack may expand very little or not at all, and all fluid connections may be maintained. For example, in some embodiments, the method comprises at least partially charging and/or discharging electrochemical cells in the battery such that the electrochemical cells undergo a cumulative expansion during the charging and/or discharging of at least 10% (and/or at least 20%, at least 30%, at least 50% and/or up to 100%, up to 200%, or more), and an expansion of the battery during the charging and/or discharging is less than or equal to 0.75%. In some such embodiments, the conduits are not breached during the cumulative expansion. In this way, the fluidic connections to the heat sinks can be maintained during the expansion of the electrochemical cells. The cumulative expansion of the electrochemical cells refers to the sum of the changes in thicknesses of the electrochemical cells themselves, not counting any other components of the battery (e.g., foams, sensors, plates, etc.). Examples of such modes of operation are described, for example, in International Patent Application Publication No. WO 2021/102071; filed Nov. 19, 2020; published on May 27, 2021; and entitled “Batteries, and Associated Systems and Methods,” which is incorporated herein by reference in its entirety.

Some aspects are generally directed to the arrangement and configuration of the electrochemical cells and heat sinks contained within the housing of the battery module. For instance, in some embodiments, as shown in the example embodiment of FIG. 1B, electrical connections (e.g., tabs 132) from electrochemical cells and fluidic connections (e.g., conduits 142) from heat sinks may be present on a single interface of the battery module. An “interface,” as described herein, includes all the surfaces viewable from a single direction when viewing a surface perpendicularly from the surface. In some embodiments, an interface comprises multiple surfaces that are partially angled relative to the surface from which the interface is viewed, which may still be viewable and considered part of the interface. In some embodiments, the interface consists of a single surface, e.g., substantially a single plane corresponding to a side of the battery module. For instance, referring again to FIGS. 1B and 4A, the surface from which the electrical connections and fluidic connections extend may be considered an interface, as when viewed perpendicularly from the surface, no other surfaces of the battery module may be visible. To establish fluidic connections, the interface may include openings through which conduits may extend, as described in more detail elsewhere herein.

In some embodiments, a battery module may include an electrical connection spanning an interface and establishing electrical communication between at least one terminal of the plurality of electrochemical cells and a terminal outside the housing. For example, electrical connections 112a and 112b depicted in FIGS. 1A and 4A-4C (with the arrow from 112b pointing to an electrical connection that is hidden in FIG. 1A, but which is shown in FIG. 4A) are configured to establish electrical connection to at least one terminal of the electrochemical cells contained within the housing of the battery module. As illustrated most clearly in FIG. 4A, electrical connection 112a is present at the left most end of the depicted interface of battery module 100 and electrical connection 112b is present at the right most end of the interface. These electrical connections are electrically connected to tabs or other terminals of the electrochemical cells (directly or indirectly) and, accordingly, they form a part of an electrical connection that spans interface 150 of the battery module 100. The electrical connections, in some embodiments, may be configured to establish electrical communication between at least one terminal of the plurality of electrochemical cells and a terminal outside the housing, e.g., by electrically connecting the outside terminal to the electrical connection. In some embodiments, the electrical connections establish electrical communication between at least one terminal of the plurality of electrochemical cells and a terminal outside the housing,

In some embodiments, a battery module may further include a conduit extending from the interior volume of the housing to an exterior of the housing through the interface. In some embodiments, fluidic connection to the conduit, e.g., to a fluid manifold as described in more detail elsewhere herein, may facilitate fluid flow through the interface. Advantageously, having electrical connections and fluidic connections through the same interface may facilitate smooth surfaces (e.g., no connections thereto) elsewhere on the battery module. In some embodiments, the surfaces other than the interface through which electrical and/or fluidic connections are made may have no external connections thereto during operation of the battery module. Such an arrangement, in some embodiments, may advantageously facilitate placement and/or arrangement of the battery module in certain applications where volume is limited and/or access to the battery module may be limited, e.g., electric cars. In some embodiments, smooth and/or flat surfaces other than the interface may additionally or alternatively facilitate stacking of the battery modules. For example, referring again to FIG. 1C, the top surface 110a and the bottom surface 110b of the housing 110 of battery module 100 are both smooth, flat surfaces without any electrical or fluidic connections therethrough, which may facilitate stacking of such battery modules.

The battery modules described herein may be, in some embodiments, rechargeable. In some embodiments, at least one electrode of an electrochemical cell in the battery module comprises lithium metal and/or a lithium metal alloy as an electrode active material during at least a portion of a charge/discharge cycle.

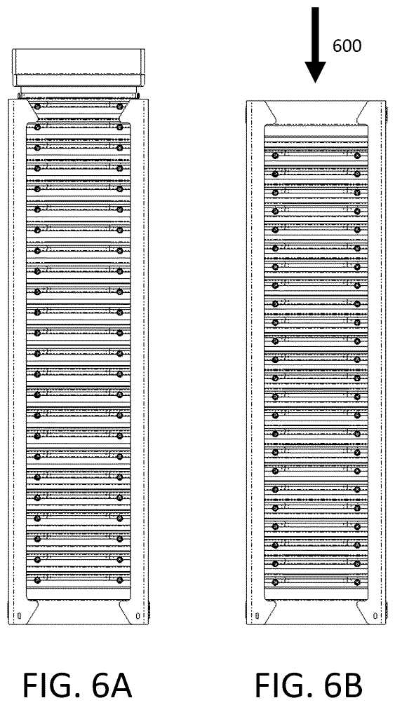

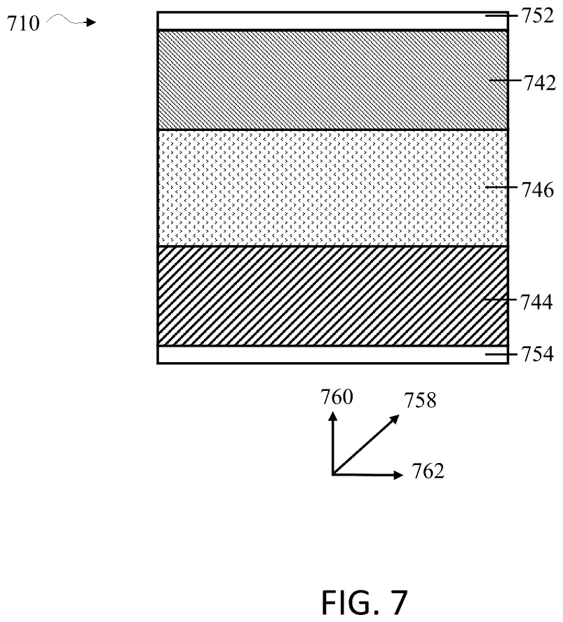

The battery modules described herein, in some embodiments, include a housing which may comprise any of a variety of suitable materials. In some embodiments, the housing comprises carbon fiber and/or aluminum. In some embodiments, the housing comprises carbon fiber. In some embodiments, the housing comprises aluminum. Other materials are also possible for the housing of the battery module, in some embodiments, as this disclosure is not so limited. In some embodiments, the housing of the battery module may be configured to apply an anisotropic force to the electrochemical cell, e.g., during operation of the battery module. For instance, FIGS. 6A and 6B show an example of a battery module before and after an anisotropic force is applied to the electrochemical cells contained therein, respectively. The direction of the anisotropic force in this depiction is indicated as arrow 600.

In some embodiments, the battery modules described herein include one or more electrochemical cells. In some embodiments, the battery module includes a plurality of electrochemical cells. In certain cases, the one or more electrochemical cells are contained within the housing of the battery module, e.g., within the interior volume defined by the housing. In some embodiments, the one or more electrochemical cells within the interior volume each have a first terminal of a first polarity (e.g., associated with an anode) and a second terminal having a second polarity opposite the first polarity (e.g., associated with a cathode). Referring again to FIG. 2, electrochemical cell 130 includes tabs 132 for connecting to the first terminal of a first polarity and the second terminal of a second polarity of the electrochemical cell.

The electrochemical cells described herein may comprise any of a variety of components, including, but not limited to, a first electrode, a second electrode, and/or an electrolyte. FIG. 7 illustrates an example of one such set of embodiments. As shown in FIG. 7, electrochemical cell 710 comprises first electrode 742 (e.g., a cathode), second electrode 744 (e.g., an anode, such as an anode comprising lithium metal, a lithium metal anode), and electrolyte 746 in electrochemical communication with (e.g., disposed between) first electrode 742 and second electrode 744. In some embodiments, the electrolyte may be a liquid electrolyte, a gel electrolyte, or a solid electrolyte.

In certain cases, the electrochemical cell may include a separator disposed between the first electrode and the second electrode. In some embodiments, the separator comprises porous separator materials that contain a non-solid electrolyte (e.g., a liquid electrolyte). For example, referring to FIG. 7, a porous separator (not shown) may be used to house electrolyte 746 and may be positioned between first electrode 742 and second electrode 744. Alternatively, in certain embodiments, the electrolyte may be a solid-state electrolyte or gel electrolyte that functions as a separator in addition to its electrolyte function.

A variety of anode active materials are suitable for use with the anodes of the electrochemical cells described herein, according to certain embodiments. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium (e.g., lithium metal and/or a lithium metal alloy) during a portion of a charging and/or discharging process of the electrochemical cell, but is free of lithium metal and/or a lithium metal alloy at a completion of a discharging process.

In some embodiments, the anode active material contains at least 50 wt % lithium. In some cases, the anode active material contains at least 75 wt %, at least 90 wt %, at least 95 wt %, or at least 99 wt % lithium.

In some embodiments, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In certain cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In certain embodiments, the anode active material comprises silicon, lithium, and/or any alloys of combinations thereof. In certain embodiments, the anode active material comprises lithium titanate (Li₄Ti₅O₁₂, also referred to as “LTO”), tin-cobalt oxide, or any combinations thereof.

A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In certain embodiments, the cathode active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In certain cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material comprises a conversion compound. For instance, the cathode may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co3O4), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material may be doped with one or more dopants to alter the electrical properties (e.g., electrical conductivity) of the cathode active material. Non-limiting examples of suitable dopants include aluminum, niobium, silver, and zirconium.

In some embodiments, the cathode active material may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and one or more components of the electrolyte, thereby suppressing side reactions.

In certain embodiments, the cathode active material comprises sulfur. In some embodiments, the cathode active material comprises electroactive sulfur-containing materials. “Electroactive sulfur-containing materials,” as used herein, refers to electrode active materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within an electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, each of which is incorporated herein by reference in its entirety for all purposes. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., each of which is incorporated herein by reference in its entirety for all purposes. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., each of which is incorporated herein by reference in its entirety for all purposes.

One or more electrodes may further comprise additional additives, such as conductive additives, binders, etc., as described in U.S. Pat. No. 9,034,421 to Mikhaylik et al.; and U.S. Patent Application Publication No. 2013/0316072, each of which is incorporated herein by reference in its entirety for all purposes.

In some embodiments, an anisotropic force with a component normal to an electrode surface the electrochemical cell is applied during at least one period of time during charge and/or discharge of the electrochemical device. In some embodiments, the force may be applied continuously, over one period of time, or over multiple periods of time that may vary in duration and/or frequency. The anisotropic force may be applied, in some cases, at one or more pre-determined locations, optionally distributed over an active surface of the one or more of the electrochemical cells of the electrochemical device. In some embodiments, the anisotropic force is applied uniformly over one or more active surfaces of the anode.

FIG. 7 depicts a schematic illustration of a force that may be applied to electrochemical cell 710 in the direction of arrow 758, according to some embodiments. Arrow 760 illustrates the component of force 758 that is normal to an electrode surface of electrochemical cell 710, according to certain embodiments. Arrow 762 illustrates the component of force 758 that is parallel to an electrode surface of electrochemical cell 710.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an electrode such as an anode, is given its ordinary meaning as would be understood by those of ordinary skill in the art and includes, for example, a force which, at least in part, exerts itself in a direction substantially perpendicular to the surface. Those of ordinary skill can understand other examples of these terms, especially as applied within the description of this document.

In some embodiments, the anisotropic force can be applied such that the magnitude of the force is substantially equal in all directions within a plane defining a cross-section of the electrochemical device, but the magnitude of the forces in out-of-plane directions is substantially unequal to the magnitudes of the in-plane forces.

In one set of embodiments, electrochemical devices (e.g., housings) described herein are configured to apply, during at least one period of time during charge and/or discharge of the cell, an anisotropic force with a component normal to an electrode surface of one of the electrochemical cells (e.g., first electrochemical cell, second electrochemical cell). In such an arrangement, the electrochemical cell may be formed as part of a container which applies such a force by virtue of a “load” applied during or after assembly of the cell, or applied during use of the electrochemical device as a result of expansion and/or contraction of one or more components of the electrochemical device itself.

The magnitude of the applied force is, in some embodiments, large enough to enhance the performance of the electrochemical device. An electrode active surface (e.g., anode active surface) and the anisotropic force may be, in some instances, together selected such that the anisotropic force affects surface morphology of the electrode active surface to inhibit increase in electrode active surface area through charge and discharge and wherein, in the absence of the anisotropic force but under otherwise essentially identical conditions, the electrode active surface area is increased to a greater extent through charge and discharge cycles. “Essentially identical conditions,” in this context, means conditions that are similar or identical other than the application and/or magnitude of the force. For example, otherwise identical conditions may mean an electrochemical device that is identical, but where it is not constructed (e.g., by couplings such as brackets or other connections) to apply the anisotropic force on the subject electrochemical device.

As described herein, in some embodiments, the surface of an anode can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the anode. For example, for an anode comprising lithium, the cell may, in some but not necessarily all embodiments, be under an externally-applied anisotropic force with a component defining a pressure at least 10 kg_{f}/cm², at least 20 kg_{f}/cm², or more. This is because the yield stress of lithium is around 7-8 kg_{f}/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling under at least about 10 kg_{f}/cm², at least about 20 kg_{f}/cm², and/or up 30 kg_{f}/cm², up to 40 kg_{f}/cm² of externally-applied pressure, the lithium surface may become smoother with cycling when the pressing surface is smooth.

In some cases, one or more forces applied to the cell have a component that is not normal to an electrode surface of an electrochemical cell (e.g., an anode). In one set of embodiments, the sum of the components of all applied anisotropic forces in a direction normal to any electrode surface of the electrochemical device is larger than any sum of components in a direction that is non-normal to the electrode surface. In some embodiments, the sum of the components of all applied anisotropic forces in a direction normal to any electrode surface of the electrochemical device is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the electrode surface.

In some cases, electrochemical cells are pre-compressed before they are inserted into housings (e.g., into housing 110 of battery module 100, as shown in FIG. 1A), and, upon being inserted into the housing, they may expand to produce a net force on the electrochemical cells. Such an arrangement may be advantageous, for example, if the electrochemical cells are capable of withstanding relatively high variations in pressure.

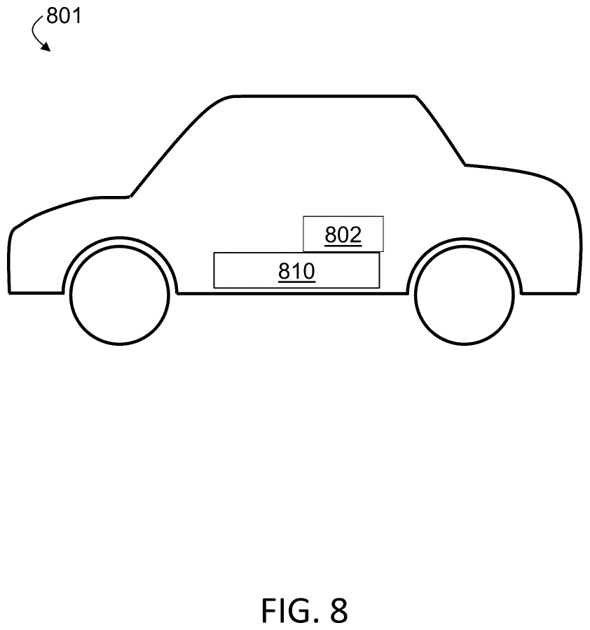

In some embodiments, battery modules described in this disclosure can be used to provide power to an electric vehicle or otherwise be incorporated into an electric vehicle. As a non-limiting example, battery modules described in this disclosure (e.g., comprising lithium metal and/or lithium alloy electrochemical cells) can, in certain embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, high altitude aircraft, drone, and/or any other suitable type of vehicle. In some embodiments, the vehicle is an aerospace vehicle. For example, the vehicle may be a spacecraft. FIG. 8 shows a cross-sectional schematic diagram of electric vehicle 801 in the form of an automobile comprising a battery module 810 and controller 802, in accordance with some embodiments. In some embodiments, the battery module 810 can provide power to a drive train of electric vehicle 801.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010, patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2006-0238203-A1 published on Oct. 26, 2006, filed as U.S. application Ser. No. 11/111,262 on Apr. 20, 2005, patented as U.S. U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on September 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624/641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, patented as U.S. Pat. No. 11,557,753 on Jan. 17, 2023, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848/659 on Sep. 9, 2015, patented as U.S. Pat. No. 11,038,178 on Jun. 15, 2021, and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020, and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021, and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021, and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021, and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019. patented as U.S. Pat. No. 11,183,690 on Nov. 23, 2021, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, patented as U.S. Pat. No.11,251,501 on Feb. 15, 2022, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. application Ser. No. 16/527,903 on Jul. 31, 2019, patented as U.S. Pat. No.11,489,348 on Nov. 1, 2022, and entitled “MULTIPLEXED CHARGE DISCHARGE BATTERY MANAGEMENT SYSTEM”; U.S. Publication No. US-2020-0220146-A1 published Jul. 9, 2020, filed as U.S. application Ser. No. 16/724,586 on Dec. 23, 2019, patented as U.S. Pat. No. 11,322,804 on May 3, 2022, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, patented as U.S. Pat. No. 11,637,353 on Apr. 25, 2023, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, patented as U.S. Pat. No. 11,710,828 on Jul. 25, 2023, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, patented as U.S. Pat. No. 11,699,780 on Jul. 11, 2023, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. 2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, patented as U.S. U.S. Pat. No. 11,424,492 on Aug. 23, 2022, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY”, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, patented as U.S. Pat. No. 11,978,917 on May 7, 2024, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, patented as U.S. Pat. No. 11,984,575 on May 14, 2024, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, patented as U.S. Pat. No. 12,051,829 on Jul. 30, 2024, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, patented as U.S. Pat. No. 11,791,511 on Oct. 17, 2023, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, patented as U.S. Pat. No. 11,824,228 on Nov. 21, 2023, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”; U.S. Publication No. 2022-0069593 published on Mar. 3, 2022, filed as U.S. application Ser. No. 17/463,467 filed on Aug. 31, 2021, and entitled “Multiplexed Battery Management System”; U.S. Publication No. 2022-0048121 published on Feb. 17, 2022, filed as U.S. application Ser. No. 17/397,114 filed on Aug. 9, 2021, and entitled “Ultrasonic Blade for Cutting a Metal”, U.S. Publication No. 2022-0115715 published on Apr. 14, 2022, filed as U.S. application Ser. No. 17/479,299 filed on Sep. 20, 2021 and entitled “Electrolytes for Reduced Gassing; U.S. Publication No. 2022-0359902 published on Nov. 10, 2022, filed as U.S. application Ser. No. 17/621,409 filed on Dec. 21, 2021, and entitled “METHODS, SYSTEMS, AND DEVICES FOR APPLYING FORCES TO ELECTROCHEMICAL DEVICES”; U.S. Publication No. 2022-0352521 published on Nov. 3, 2022, filed as U.S. application Ser. No. 17/730,792 on Apr. 27, 2022, and entitled “INTEGRATED BATTERY ELECTRODE AND SEPARATOR”; U.S. Publication No. 2022-0336872 published on Oct. 20, 2022, filed as U.S. application Ser. No. 17/592,406 on Feb. 3, 2022, and entitled “CHARGE/DISCHARGE MANAGEMENT IN ELECTROCHEMICAL CELLS, INCLUDING PARTIAL CYCLE CONTROL”; U.S. Publication No. 2022-0328880 published on Oct. 13, 2022, filed as U.S. application Ser. No. 17/712,754 on Apr. 4, 2022, and entitled “ELECTROLYTES FOR LITHIUM BATTERIES”; U.S. Publication No. 2022-0320586 published on Oct. 6, 2022, filed as U.S. application Ser. No. 17/703,415 on Mar. 24, 2022, and entitled “IN-SITU CONTROL OF SOLID ELECTROLYTE INTERFACE FOR ENHANCED CYCLE PERFORMANCE IN LITHIUM METAL BATTERIES”; U.S. Publication No. 2022-0311081 published on Sep. 29, 2022, filed as U.S. application Ser. No. 17/702,971 on Mar. 24, 2022, and entitled “BATTERY PACK AND RELATED COMPONENTS AND METHODS”; U.S. Publication No. 2022-0271537 published on Aug. 25, 2022, filed as U.S. application Ser. No. 17/592,398 on Feb. 3, 2022, and entitled “CHARGE/DISCHARGE MANAGEMENT IN ELECTROCHEMICAL CELLS, INCLUDING PARTIAL CYCLE CONTROL”; U.S. Publication No. 2022-0209327 published on Jun. 30, 2022, filed as U.S. application Ser. No. 17/565,317 on Dec. 29, 2021, and entitled “TEMPERATURE MANAGEMENT FOR ELECTROCHEMICAL CELLS”; U.S. Publication No. 2022-0199968 published on Jun. 23, 2022, filed as U.S. application Ser. No. 17/552,829 on Dec. 16, 2021, and entitled “LASER CUTTING OF COMPONENTS FOR ELECTROCHEMICAL CELLS”; U.S. Publication No. 2022-0181624 published on Jun. 9, 2022, filed as U.S. application Ser. No. 17/540,611 on Dec. 2, 2021, and entitled “LOW POROSITY ELECTRODES AND RELATED METHODS”; U.S. Publication No. 2022-0181624 published on Jun. 9, 2022, filed as U.S. application Ser. No. 17/492,084 on Oct. 1, 2021, and entitled “ELECTROCHEMICAL CELLS COMPRISING NITROGEN-CONTAINING SPECIES, AND METHODS OF FORMING THEM”; U.S. Publication No. 2023-0006185 published on Jan. 5, 2023, filed as U.S. application Ser. No. 17/849,890 on Jun. 27, 2022, and entitled “SYSTEMS AND METHODS FOR ROLL TO ROLL DEPOSITION OF ELECTROCHEMICAL CELL COMPONENTS AND OTHER ARTICLES”; U.S. Publication No. 2022-0407127 published on Dec. 22, 2022, filed as U.S. application Ser. No. 17/849,814 on Jun. 27, 2022, and entitled “SYSTEM AND METHOD FOR OPERATING A RECHARGEABLE ELECTROCHEMICAL CELL OR BATTERY”; U.S. Publication No. 2023-0118071 published on Apr. 20, 2023, filed as U.S. application Ser. No. 17/911,080 on Sep. 12, 2022, and entitled “APPLICATION OF PRESSURE TO ELECTROCHEMICAL DEVICES INCLUDING DEFORMABLE SOLIDS, AND RELATED SYSTEMS”; U.S. Publication No. 2023-0111336 published on Apr. 13, 2023, filed as U.S. application Ser. No. 17/942,469 on Sep. 12, 2022, and entitled “HIGH VOLTAGE LITHIUM-CONTAINING ELECTROCHEMICAL CELLS AND RELATED METHODS”; U.S. Publication No. 2023-0112241 published on Apr. 13, 2023, filed as U.S. application Ser. No. 17/942,489 on Sep. 12, 2022, and entitled “HIGH VOLTAGE LITHIUM-CONTAINING ELECTROCHEMICAL CELLS INCLUDING MAGNESIUM-COMPRISING PROTECTIVE LAYERS AND RELATED METHODS”; U.S. Publication No. 2023-0317959-A1 published on Oct. 5, 2023, filed as U.S. application Ser. No. 18/024,229 on Mar. 1, 2023, and entitled “ELECTRICALLY CONDUCTIVE RELEASE LAYER”; U.S. Publication No. US-2023-0275256-A1 published on Aug. 31, 2023, filed as U.S. application Ser. No. 18/017,493 on Jan. 23, 2023, and entitled “ELECTROCHEMICAL CELL CLAMPS AND RELATED METHODS”; U.S. Publication No. 2022-0115649-A1 published on Apr. 14, 2022, filed as U.S. application Ser. No. 17/492,063 on Oct. 1, 2021, patented as U.S. Pat. No. 11,705,554 on Jul. 18, 2023, and entitled “ELECTROCHEMICAL CELLS AND/OR COMPONENTS THEREOF COMPRISING NITROGEN-CONTAINING SPECIES, AND METHODS OF FORMING THEM”; U.S. Publication No. 2024-0097208-A1 published on Mar. 21, 2024, filed as U.S. application Ser. No. 18/270,720 on Jun. 30, 2023, and entitled “MIXTURES AND/OR LAYERS COMPRISING CERAMIC PARTICLES AND A POLYMERIC SURFACTANT, AND RELATED ARTICLES AND METHODS”.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %”is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A battery module, comprising:
a housing defining an interior volume;
an electrochemical cell within the interior volume; and
a heat sink within the interior volume, the heat sink comprising a conduit extending from the interior volume of the housing to an exterior of the housing through an opening in the housing,
wherein the opening in the housing is sized to permit movement of the conduit in a first direction that is substantially perpendicular to a second direction in which fluid is configured to flow through the conduit.

2. A battery module, comprising:
a housing defining an interior volume and comprising an interface;
a plurality of electrochemical cells within the interior volume, each electrochemical cell having a first terminal of a first polarity and a second terminal having a second polarity opposite the first polarity;
a heat sink within the interior volume;
an electrical connection spanning the interface and establishing electrical communication between at least one terminal of the plurality of electrochemical cells and a terminal outside the housing; and
a conduit extending from the interior volume of the housing to an exterior of the housing through the interface.

3. A battery module, comprising:
a housing defining an interior volume;
an electrochemical cell within the interior volume;
a heat sink within the interior volume comprising a fluid flow pathway within the heat sink,
a fluid manifold; and
a flexible conduit fluidically connecting the fluid manifold and the fluid flow pathway.

4. The battery module of claim 1, wherein there is a plurality of electrochemical cells within the interior volume of the housing.

5. The battery module of claim 4, wherein there is a plurality of heat sinks within the interior volume of the housing.

6. The battery module of claim 5, wherein the plurality of electrochemical cells and the plurality of heat sinks are arranged within the interior volume of the housing such that the electrochemical cells and heat sinks alternate.

7. The battery module of claim 3, wherein the fluid flow pathway of the heat sink comprises an inlet and an outlet, and each of the inlet and the outlet extend from the interior volume of the housing to the exterior of the housing through a respective opening.

8. The battery module of claim 1, wherein the housing is configured to apply an anisotropic force to the electrochemical cell.

9. The battery module of claim 1, wherein the electrochemical cell comprises an electrode comprising lithium metal as an electrode active material.

10. The battery module of claim 3, wherein the fluid manifold is configured to be reversibly attached to the housing of the battery module.

11. The battery module of claim 3, wherein the fluid manifold is an integral part of the housing.

12. The battery module of claim 1, wherein the fluid comprises water.

13. The battery module of claim 1, wherein the heat sink comprises a thermally conductive material.

14. The battery module of claim 1, wherein the electrochemical cell is a rechargeable electrochemical cell.

15. A vehicle comprising the battery module of claim 1.

16. A method of operating the battery module of claim 1, comprising charging and/or discharging electrochemical cells in the battery module such that the electrochemical cells undergo a cumulative expansion during the charging and/or discharging of at least 10%, and the conduit is not breached during the cumulative expansion.
